(19) United States
(12) Patent Application Publication
(10) Pub. No.: US 2017/0148098 A1
(43) Pub. Date: May 25, 2017

(54) DATA CREATING, SOURCING, AND AGREGATING REAL ESTATE TOOL

(71) Applicant: 50,000 plus LLC, DBA REPROPHET.com, West Hartford, CT (US)

(72) Inventors: Matthew Miale, West Hartford, CT (US); Matthew Erdmann, Simsbury, CT (US)

(21) Appl. No.: 15/359,687

(22) Filed: Nov. 23, 2016

Related U.S. Application Data
(60) Provisional application No. 62/258,718, filed on Nov. 23, 2015.

(51) Int. Cl. G06Q 40/06; G06Q 50/16

(52) U.S. Cl. CPC G06Q 40/06; G06Q 50/16

(57) ABSTRACT

Embodiments herein relate to a computer-implemented method for aggregating financial institution account transactions to generate real estate financial transaction data. The computer-implemented method includes retrieving the financial institution account transactions from one or more financial institutions. The computer-implemented method includes automatically sourcing the financial institution account transactions by identifying each transaction of the plurality of financial institution account transactions as specific to one or more real estate sales to generate sourced financial information and automatically categorizing the sourced financial information to generate the real estate financial transaction data. The computer-implemented method includes analyzing the real estate financial transaction data to determine a return on the real estate sales.

### CROSS-REFERENCE TO RELATED APPLICATIONS

This application claims priority to and the benefit of U.S. Provisional Application Ser. No. 62/258,718 filed on Nov. 23, 2015, the content of which is incorporated herein in their entirety by reference.

### BACKGROUND

Embodiments described herein relate to a data creation and sorting tool for real estate finance management, and more specifically, to a real estate finance management mechanism that provides in-depth data creation, analysis, and sorting with industry-specific operability.

Contemporary finance management services are targeted at general consumers. In turn, real estate professionals that utilize contemporary finance management services have difficulty tracking their professional finances (especially when their professional finances blend with their personal finances) because contemporary finance management services do not include real estate tracking functionality that attributes specific sources of income back to expenditures. In addition, contemporary finance management services also fail to provide easy access to professional and professional finances from a single interface.

### BRIEF DESCRIPTION OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 depicts a processing system in accordance with one or more embodiments;

FIG. 2 depicts an account management interface for presenting a detailed transaction list for a selected account in accordance with one or more embodiments;

FIG. 3 depicts a process flow by a real estate finance management application in accordance with one or more embodiments;

FIG. 4A depicts an interface flow of a real estate finance management application in accordance with one or more embodiments;

FIG. 4B depicts an interface flow of a real estate finance management application in accordance with one or more embodiments;

FIG. 5 an interface of a real estate finance management application in accordance with one or more embodiments; and

FIG. 6 a process flow by a real estate finance management application in accordance with one or more embodiments.

### DETAILED DESCRIPTION

In general, a real estate finance management mechanism is configured to automate a manipulation of real estate financial transaction data for real estate agents into pre-bucketed budget line items to produce return on investment reports and profit and loss statements. The real estate finance management mechanism implements computer services to manipulate the real estate financial transaction data.

An example service includes a data aggregation by the real estate finance management mechanism that retrieves, categorizes, and stores financial institution account transactions related to real estate as real estate financial transaction data. For instance, the data aggregation executes an automatic financial institution account transaction import for each user of the real estate finance management mechanism to retrieve raw data. The real estate finance management mechanism creates sourced financial information from the raw data by identifying individual account transactions of the raw data specific to the real estate industry and categorizing those identified real estate transactions into the pre-bucketed budget line items to output the sourced financial information. Over time, the sourced financial information accumulates thereby creating a real estate data pool (e.g., the real estate financial transaction data) from which the real estate finance management mechanism can provide real and verifiable analyses of an expenditure's potential of to result in a real estate sale. In this way, the technical effects and benefits of the real estate finance management mechanism include utilizing newly created, sourced, and aggregated real estate financial transaction data to provide an indicator that tells real estate agents where and how to spend their money and that tells brokerages on which relationship are the most valuable. Further, the indicator can be geographically granular such that the real estate agents and the brokerages can determine which sourced financial information are more effective on for different areas, from a street level to a country level.

An example service includes a finance management website of the real estate finance management mechanism that provides real estate professionals industry-specific operability with respect to updating categorizations for the real estate financial transaction data, adding additional income reporting information, utilizing financial performance reports, and the like. For instance, a real estate agent can utilize the finance management website to aggregate all of their account transactions across multiple back accounts and multiple credit cards. The finance management web site can then identify and source (along with categorize) any credit transactions of the account transactions that relate to a real estate sale. Also, the finance management website can identify and source (along with categorize) any debit transactions of the account transactions that may have led to the same real estate sale. The finance management website may also assign percentages with respect to how much each credit and/or debit transaction associated with the real estate sale contributed to that sale. By categorizing and sourcing credit and debit transactions, the finance management web site is creating a new type of data (e.g., sourced financial information) that can be aggregated (e.g., the real estate financial transaction data) and leveraged to inform, through return on investment reports and profit and loss statements provided by the finance management website, the real estate agent and brokerages which credit and debit transactions (e.g., the financial institution account transactions) will most likely lead to a real estate sale.

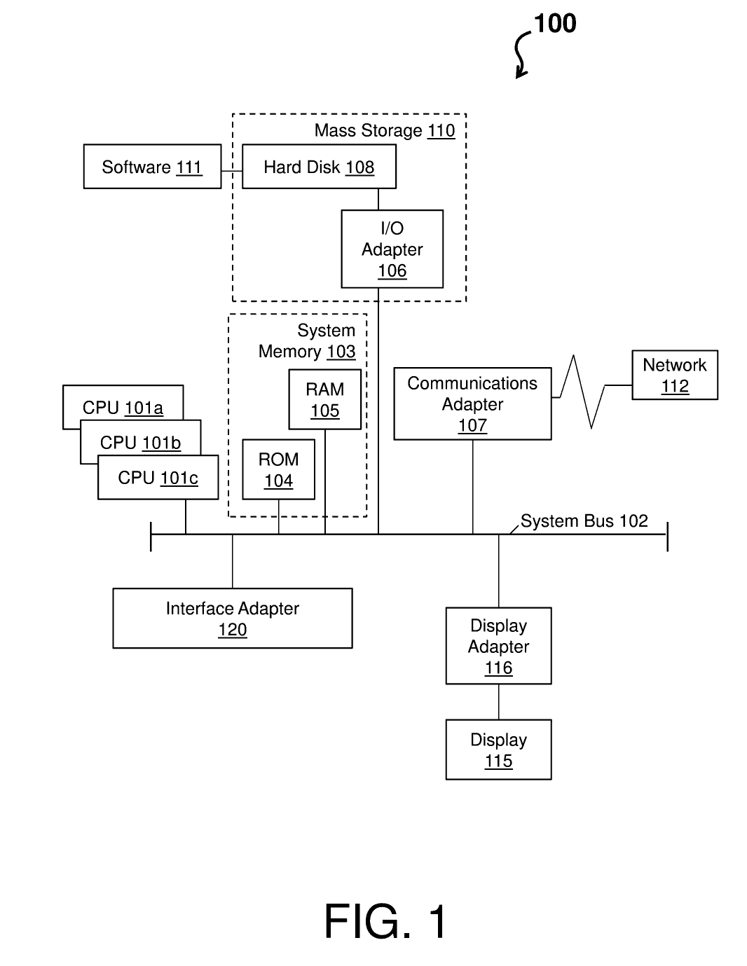

The real estate finance management can be an electronic, computer framework comprising and/or employing any number and combination of computing device and networks utilizing various communication technologies, as described herein. The real estate finance management can be easily scalable, extensible, and modular, with the ability to change to different services or reconfigure some features independently of others. Turning now to FIG. 1, an example of the real estate finance management mechanism is generally shown implemented in a processing system 100 in accordance with one or more embodiments.

In this embodiment, the processing system 100 has one or more central processing units (processors) 101a, 101b, 101c, etc. (collectively or generically referred to as processor(s) 101). The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS), which controls certain basic functions of the processing system 100. RAM is read-write memory coupled to the system bus 102 for use by the processors 101.

FIG. 1 further depicts an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110. A software 111 for execution on the processing system 100 may be stored in the mass storage 110. The mass storage 110 is an example of a tangible storage medium readable by the processors 101, where the software 111 is stored as instructions for execution by the processors 101.

The software 111 can be configured as a real estate finance management application, which is an example implementation of the real estate finance management mechanism described herein. The real estate finance management application can be built on a software framework that supports, through significant amounts of custom code implementing core application logic, advanced web application operability, such as utilizing a number of libraries, performing authentication and user management, etc. The real estate finance management application can employ a layer of security and access protection, execute a billing service to provide and accept payments (along with automated billing email notifications), perform automated marketing notifications, etc. Thus, according to one or more embodiments, the real estate finance management application can be client-host software application in which a client (or user application) runs in a web browser (i.e., a web application) and accesses a host (or server application). The real estate finance management application is configured to implement computer services to manipulate the real estate financial transaction data, such as aggregating bank accounts and credit cards to retrieve, source, categorize, and store credit and debit transactions to sourced financial information, automating the manipulation of the sourced financial information into pre-bucketed budget line items to produce a real estate data pool utilize to generate return on investment reports and profit and loss statements, managing user subscriptions to the real estate finance management application based on a fee structure, updating categorizations for the real estate financial transaction data, adding additional income reporting information, utilizing financial performance reports, etc. In this way, the user can utilize the real estate finance management application to identify and aggregate financial institution accounts and credit cards to retrieve, source, categorize, and store financial institution account transactions to create real estate financial transaction data.

The communications adapter 107 interconnects the system bus 102 with an outside network 112 enabling the processing system 100 to communicate with other such systems. A screen (e.g., a monitor or display 115) is connected to the system bus 102 by the display adapter 116, which may include a graphics controller to improve the performance of graphics intensive applications and a video controller. For instance, a plurality of user interfaces of the real estate finance management application can include an account overview interface, an account management interface, a user registration interface, user account management interface, financial institution search interface, add-financial-institution interface, edit financial institution credential interface, and delete-financial-institution interface, each of which can be provided via the display 115, the system bus 102, and the display adapter 116, etc.

In a non-limiting embodiment, the account overview interface can be utilized by the real estate finance management application to provide an account overview, while the account management interface can be utilized to enable account management and provide reports. For instance, the account overview interface can present a list of user accounts, a cash total in each account, a cash total across all accounts, etc. The account management interface can also present a list of accounts, along with a detailed transaction list for selected account, and editable categories for each transaction via the manual edit feature.

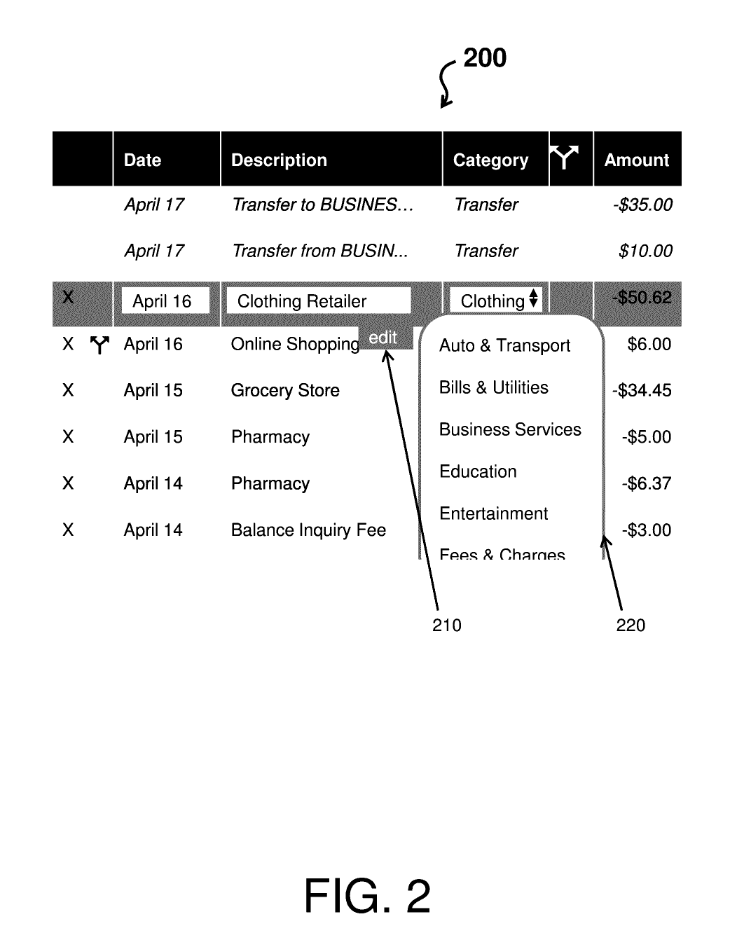

Turning now to FIG. 2, an account management interface 200 of the real estate finance management application presenting a detailed transaction list for a selected account is illustrated according to one or more embodiments. The account management interface 200 includes a manual edit feature. The manual edit feature enables fields in a debit or credit transaction to become editable, and also for an edit details tab 210 to be presented by the account management interface. The edit details tab 210 can utilize expansion boxes to accept additional data entries or selections about a selected debit or credit transaction. Note that debits transactions can include three editable fields in a main transaction row: date, description, and category. When the edit details tab 210 is activated for the selected debit or credit transaction, an expanded section presents at least a source field. The source field can allow for open text entry, and a select box 220 can be provided with all existing sources already defined by the user.

The user registration interface of the real estate finance management application can be configured to perform enable selecting/assigning membership levels, receiving/providing personal information, receiving credit card payment or information, creating/managing user accounts, managing user emails, etc. Membership level can include one level at a specific price point with the option to incorporate additional membership levels as needed. Similar operations may be performed through the user account management interface by the real estate finance management application, including receiving and updating personal info (e.g., name, address, password, etc.) and payment information (e.g., credit card numbers, expiration dates, etc.).

The financial institution search and add-financial institution-interfaces of the real estate finance management application can be utilized by the real estate finance management application to perform financial institution searching and add operations. For example, the financial institution search interface provides a financial institution searching operation, where a user provides a search entry and the real estate finance management application retrieves a list of possible institution matches. The user then views the list through the financial institution search interface, and the user selects a desired financial institution.

Further, the add-financial-institution interface provides an add-financial-institution operation, where a desired financial institution is added to a user account. For example, the add financial institution operation includes selecting a financial institution, checking for duplicate financial institutions, validating user credentials for that financial institution, and acquiring financial institution account transactions from that financial institution. To check for duplicate financial institutions, the real estate finance management application can identify whether a selected financial institution is already associated with the user account, and when the selected financial institution is already associated, the real estate finance management application can notify the user and stop the add financial institution operation. To validate user credentials, the real estate finance management application retrieve authentication requirements for an identified financial institution, including any available authentication forms. Authentication requirements can include credential validation, password authentication, multifactor authentication, two-step verification, challenge questions, and the like. Thus, if during the add financial institution operation the real estate finance management application experiences an unsuccessful credential validation, the real estate finance management application can notify a user, provide options to re-attempt validation (e.g., up to 5 attempts), and/or re-execute a search for a new financial institution. Once any financial institution account is validated, the real estate finance management application can generate and store security keys, automatically discover user financial institution accounts within the added financial institution, store all the discovered user financial institution accounts, and retrieve and store all associated user financial institution account transactions.

The edit financial institution credential interface of the real estate finance management application can be utilized to edit financial institution credentials. The delete-financial-institution interface by the real estate finance management application can be utilized to delete a financial institution from a user account. In a deletion operation, the user selects financial institution to delete, the real estate finance management application prompts the user to confirm the deletion, and the real estate finance management application deletes financial institution from user account once deletion is confirmed.

The adapters 106, 107, and 116 may be connected to one or more I/O buses that are connected to the system bus 102 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to the system bus 102 via an interface adapter 120 and the display adapter 116. A keyboard, mouse, speakers and/or the like can be interconnected to the system bus 102 via the interface adapter 120, which may include, for example, a Super I/O chip integrating multiple device adapters into a single integrated circuit.

Thus, as configured in FIG. 1, the processing system 100 includes processing capability in the form of the processors 101, and, storage capability including the system memory 103 and the mass storage 110, input means such as keyboard and mouse, and output capability including the speakers and the display 115. In one embodiment, a portion of the system memory 103 and the mass storage 110 collectively store an operating system to coordinate the operations of the various components shown in FIG. 1.

Data processing operations performed by the real estate finance management application will now be described. Data processing operations relate to automatically aggregating financial institution account transactions from financial sources, such as credit and debit transactions from bank accounts and credit cards, as real estate financial transaction data (e.g., an automatic financial institution account transaction import for each user who has registered with the real estate finance management application to retrieve raw data and sourcing of that raw data to generate the real estate financial transaction data).

In one or more embodiments, the aggregation of the financial institution account transactions as the real estate financial transaction data comprises performing an automatic financial institution account transaction import. This import can occur in real-time when user accesses the real estate finance management application (e.g., on-demand transaction retrieval) and/or through a batch process performed after a designated time interval. The on-demand transaction retrieval can utilize a message queue to provide an on-demand request for new transaction data since a previous update when the user accesses the real estate finance management application. The message queue can be utilized to improve user experience and reduce server load. In this way, even if the on-demand transaction retrieval takes several minutes to execute, the user can continue to use the real estate finance management application as the real estate financial transaction data becomes available. The batch process can be a nightly batch update of transactions performed at a specific time (e.g., 6 A.M. EST) to retrieve a full list of accounts and corresponding financial institution account transactions. Note that in a non-limiting embodiment there are three types of financial institution account transactions that may be imported: pending transactions, debit transactions, and credit transactions.

Pending transactions can be credit or debit transactions that are not editable and are not used for reporting. If at any point the real estate finance management application discovers that the financial institution account transactions are pending (rather than posted), the real estate finance management application can temporarily store these transactions as pending and update these transactions once these transactions have posted. Also, the real estate finance management application can delete these temporarily stored transactions once aggregated.

Debit transactions are expenses. Credit transactions are income transactions. Debit and credit transactions are editable. These three account transactions types can then be utilized to create, source, and store the real estate financial transaction data. Note that the creating and storing the real estate financial transaction data can also be an automatic process performed by the real estate finance management application and/or through a manual edit feature accessed through one of the plurality of interfaces by directly selecting a debit or credit transactions.

In one or more embodiments, the creation of the financial data comprises sourcing and categorizing the financial institution account transactions. For instance, with respect to categorization, the financial institution account transactions can be stored in accordance with transaction categories, where text of a category description can be mapped to a unique institution transaction identifier for an internal industry specific category. A key table, such as a CategoryMap, can also be utilized for this mapping. The key table can include four columns: identification, data category, industry category, and category group identification.

Identification is a unique identifier for the mapping to be stored with each transaction. Data category is text description of the categories delivered by the real estate management application, such as restaurant, gas, etc. Industry category is a text description of the industry specific version of the category. Industry category may or may not be the same as the data category. Industry category text can appear on a transactions page with each transaction. Category group identification is an identification of a top level grouping for categories to allow rolling up categories for budget reports.

For example, there may be several categories related to food that would all roll up to a category group called “Food & Entertainment” and initial budgets can be based on the category groups. The real estate management application may also employ a category group key table. The financial data also includes, but is not limited to, calculated budget vs. user transaction data, where the budget can be expressed in dollars or percentages, where transaction categories are converted to budget categories, and where multiple date range options are used to organize the calculated budget vs. user transaction data.

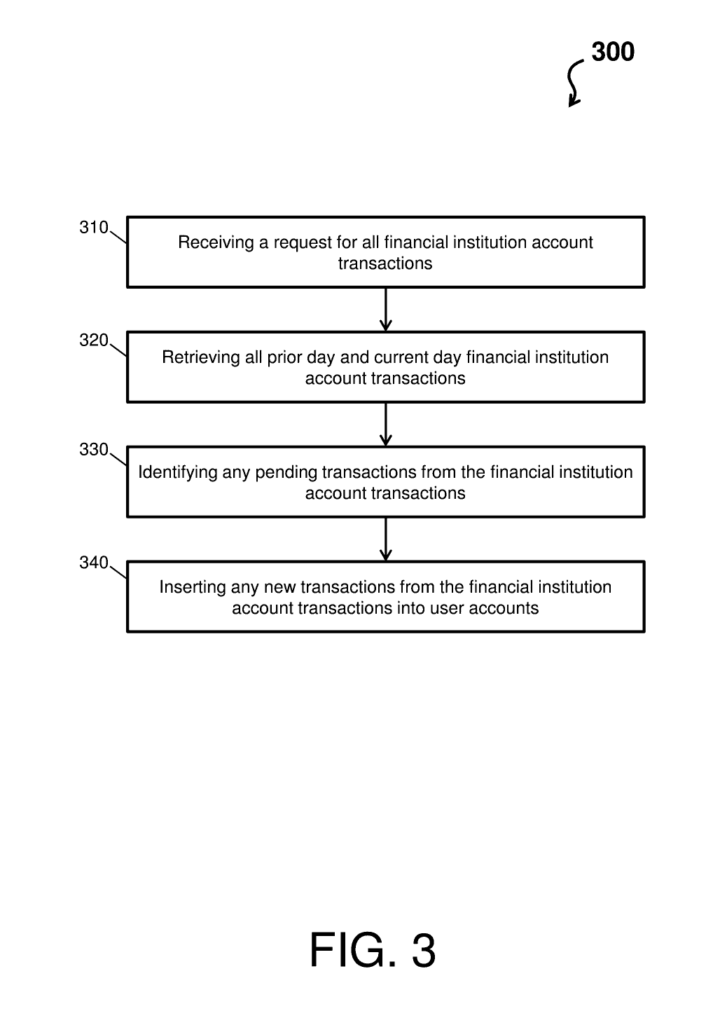

Turning now to FIG. 3, a process flow 300 for aggregating financial institution account transactions to create real estate financial transaction data is illustrated in accordance with one or more embodiments. The process flow 300 can be implemented by the real estate financial management mechanism described herein (e.g., executed as software by the real estate finance management application).

The process flow 300 begins at block 310, where a request for all user financial institution account transactions is received by the real estate finance management application. At block 320, the real estate finance management application retrieves all prior day and current day financial institution account transactions (e.g., unless the financial institution account transactions were not retrieved for a longer period of time) across all financial institution accounts across all user accounts. The real estate finance management application can perform an overlap retrieval to ensure that no transactions are missed, such as when a recently posted transaction includes a date prior to the date range. The real estate finance management application may also retrieve of date of 3-4 days prior to the current day. Optionally, the real estate finance management application can maintain a log of transaction data requests for each user/financial institution combination including the date range retrieved so future requests are only for new data since last request (e.g., reduces the amount of unnecessary data being transferred).

At block 330, the real estate finance management application identifies any pending transactions from the retrieved transactions. The real estate finance management application may then delete the identified pending transactions as the pending transactions are not used by the real estate finance management application for calculating reports/totals and are only for display purposes for the user. Also, the pending transactions will eventually be converted to final transactions, which will be retrieved at a subsequent iteration of the process flow 300 (i.e., if transactions are still pending, they will be re-inserted when final so that the real estate finance management application does not have to perform additional duplication removal operations). Note that the description for a pending transaction can often change when that pending transaction converts to final. Thus, a bulk delete of all pending transactions before each update also eliminates the need to update those descriptions.

At block 340, the real estate finance management application inserts any new transactions into user accounts (thereby creating the financial data). The real estate finance management application can use unique institution transaction identifier, such as institution TransactionID, to identify new transactions. When the real estate management application inserts a transaction, the real estate management application can compare the category to the category map table and also store the identification from that table with the transaction. The identification and data category values can be stored in an array or enumeration so it doesn't need to consult the database for every transaction. Note that a status of each transaction is identified as pending if a pending field is set to true for that transaction.

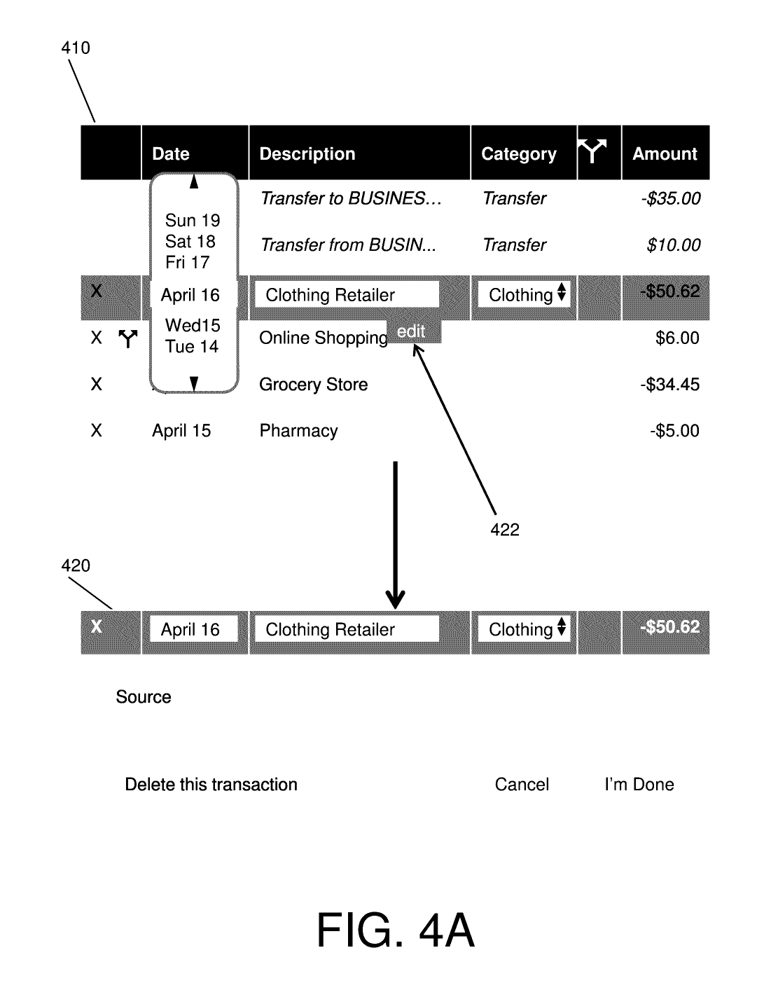

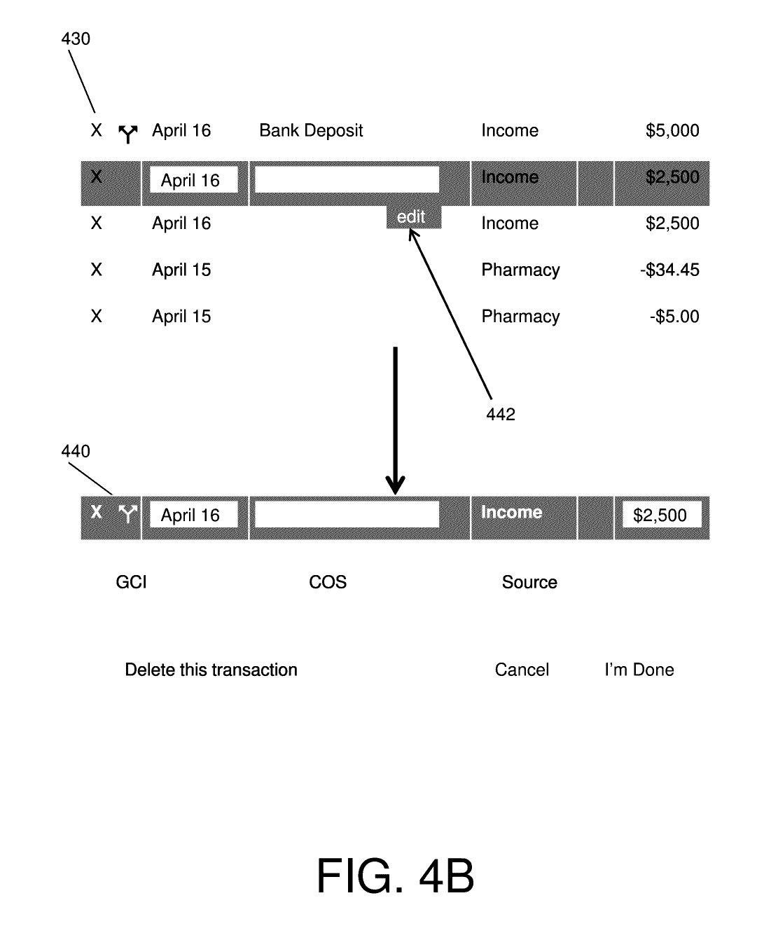

Turning now to FIG. 4A, an interface flow of a real estate finance management application is depicted in accordance with one or more embodiments. The interface flow of FIG. 4A includes two interfaces 410, 420. The interface flow transitions from the first interface 410 to the second interface 420 based on the edit details tab being selected. That is, when the edit details tab 422 is selected from the interface 410, an edit details panel is rendered (e.g., interface 420).

Turning now to FIG.4B, an interface flow of a real estate finance management application is depicted in accordance with one or more embodiments. The interface flow of FIG. 4B includes two interfaces 430, 440. The interface flow transitions from the first interface 430 to the second interface 440 based on the edit details tab being selected. That is, when the edit details tab 442 is selected from the interface 430, an edit details panel is rendered (e.g., interface 440).

Through these interfaces 410, 420, 430, 440, credit transactions are edited similarly to debits; however, the “Category” section can be hard-coded to income. Also, in the edit details panel accepts three values, gross commission income (GO), cost of sale (COS), and source (e.g., same source as in the debit transactions).

Gross Commission income is a total amount of income generated by a transaction before any cost of sales is removed (e.g., gross profit plus cost of sales). Gross profit is an amount of income from financial institution account transactions after COS has been removed, but before other expenses are removed.

Cost of sales is a total amount of commissions and fees that were taken out of a payment before the user received it. For example, a real estate agent will pay their agency a certain percentage of a transaction as part of their agreement. This value is not explicitly expressed in the transaction data, so for income transactions, users will be able to add the COS value to financial institution account transactions which allows for calculation of the total amount of revenue generated before any commissions were paid (gross commission income).

The GCI can default to be equal to the total for the transaction, and the COS can default to zero. GCI is the COS plus the total of the transaction. If the user increases the GCI value, the difference between the GCI and transaction total can be added to the COS field. For example, in a transaction with a total credit of $2 k, the GCI would start out at $2 k and the COS would be $0. If the user changes the GCI to $3 k, the COS would update to $1 k, because $1 k COS plus the $2 k transaction total equals GCI of $3 k. Conversely, if the total transaction credit is $2 k, and the user enters $1 k in the COS field, the GCI would update to $3 k.

The source has no direct relationship to the GCI and COS values. The source operates similarly to debit transactions in that it allows open text entry and also displays a select box with all existing sources defined by the user.

Credits/Income transactions will support the ability to “split” a transaction into two or more sub transactions. A use case for this is when a real estate agent receives a payment that includes income from multiple house sales, they will want the ability to break down the single transaction into multiple transactions that can be more easily tracked and understood independently from each other. The “split” icon can appear with all income transactions. Selecting the icon for the first time adds two “sub transaction” line items below the selected transaction with darker green backgrounds (and all three lines are surrounded by a dark border). The total of the transaction is then divided in two and prepopulated in the amount fields for the sub transactions. Each additional selection of the split icon will add another sub transaction line, and the amount will be split across all unset amount fields.

A process for determining the default values for sub transaction amounts includes defaulting subsequent transactions to an equal portion of the transaction total until one of the transactions is set by the user. Then, the remaining unset transactions will default to the remainder of the total amount minus the set amount. For example, when a transaction records a $10 k deposit and the user selects the split icon twice, three sub-transaction rows are created (e.g., a first click creates two rows, each additional click creates one more). Each of the three amounts is set to $3,333 (the first one sub-transaction be $3,334, as the first sub-transaction always takes the remainder if the total does not divide evenly). Then, the user can manually set the first sub-transaction amount to $2 k. This leaves $8 k from the original $10 k. The remaining two transactions are reset to $4 k each. Next, the user updates the second sub-transaction by setting it to $3 k. Now two sub-transaction rows have been defined, for $2 k and $3 k, leaving $5 k. The last sub-transaction row amount is updated to $5 k.

Note that amounts are only set dynamically if they are not set manually by the user. Once a user enters a value into an amount field for a sub-transaction, it will not update when other amounts change. Also, a field should not let the user enter more than the total for the main transaction. To use the previous example, if the first two sub-transaction rows added to $5 k leaving only $5 k for the third sub-transaction, the third row should not accept more or less than $5 k. In this way, the value for the last blank row is set by what is set is the next to last row. Returning to the example, if there are three rows with $3 k in the first row and the user enters $2 k in the second row, the third row automatically defaults to $5 k. However, if the user does not end the edit mode, they can make additional changes to the second value, e.g., change the $2 k to $4 k, and the amount in the third row will automatically change to $3 k. However, once the edit mode is ended, the values are all set. To set any of these value to a different value later, the user will have to clear the values in the two (or more) that need to changed, and then enter the new amounts. In some embodiments, the last row is always updated automatically with the remainder, if any, when the next to last row amount is set, but once an amount value is deleted, it will not update until it is set manually by the user or becomes the last unset row when the user sets other rows.

Once sub-transaction rows are defined, the main row can no longer be edited. However, the sub-transaction rows each have the same edit details tab as the regular transactions to set the GCI/COS and Source for each sub-transaction. Note that all text in sub-transaction rows can be italic with a colored background. When an income transaction with sub-transactions is not in edit mode, the transaction list layout communicates to the user that these are all part of one main transaction representing multiple payments/income.

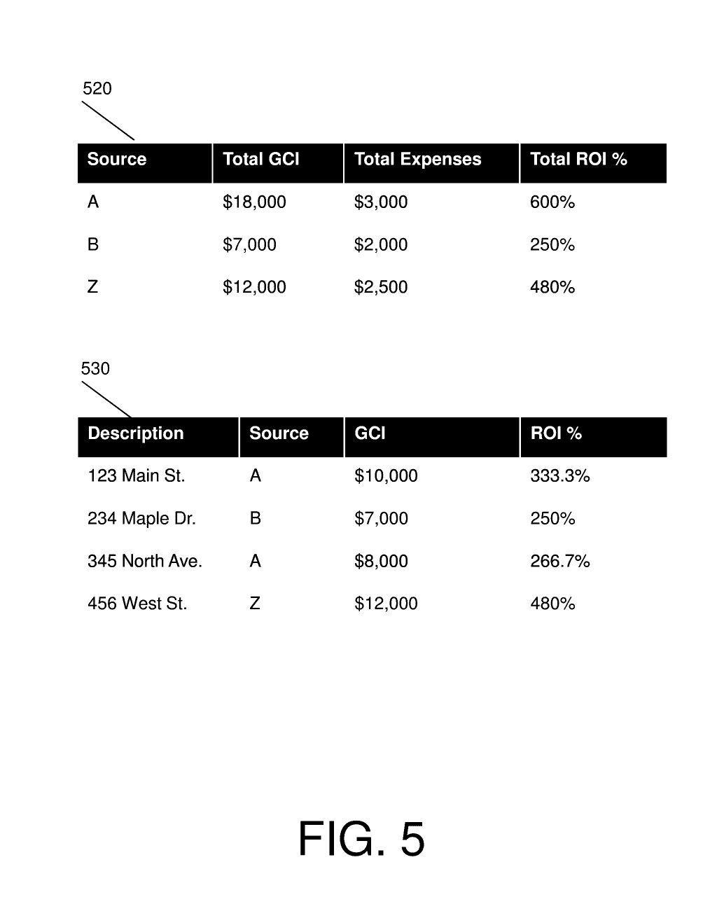

Turning now to FIG. 5, report section interfaces of the real estate finance management application is depicted in accordance with one or more embodiments. To render the report section interfaces of FIG. 5, a selection options menu can be utilized. The selection options menu can include a select date range field where date range of the user's data is selected and use for report calculations. The report section interfaces includes a total return on investment (ROI) report 520 and an income report 530.

The total ROI report 520 depicts table headers of Source, Total Gross Commission Income (GCI), Total Expenses, and Total ROI. In general, the total ROI report 520 rolls up the Total GCI and the Total Expenses for each Source. Source is a value, which can be user provided, that creates a relationship between profits and expenses to allow calculation of ROI % of the income report 530. Total GCI is a total amount of income generated by all real estate sales associated with a Source before any costs of sales are removed. Total Expenses are the sum of financial institution account transactions sourced/mapped to the Source. The total ROI % is equal to the Total GCI divided by the Total Expenses multiplied by a hundred.

The income report 530 depicts table headers of Description, Source, GCO, and ROI. The income report 530 displays all credits/income transactions with the Source and GCI for each real estate sale. Description is an identification of the real estate sale. The Source is the value, which can be user provided, that creates the relationship between profits and expenses to allow calculation of ROI %. Gross Commission income is a total amount of income generated by that particular real estate sale before any cost of the sale is removed. The ROI % for each transaction is the GCI for that transaction divided by the total expenses for that source type multiplied by a hundred. For example, for 123 Main St., the source A has total expenses of $3,000 from the total ROI report 520 and the GCI is $10,000 from the income report 530. In turn, the ROI % is calculated by 10,000 / 3,000*100, which is equal to 333.3%. Further, for 345 North Ave., the source A has total expenses of $3,000 from the total ROI report 520 and the GCI is $8,000 from the income report 530. In turn, the ROI % is calculated by 10,000/8,000*100, which is equal to 266.7%. The total of 333.3% and 266.7% equates to the Total ROI % of 600%.

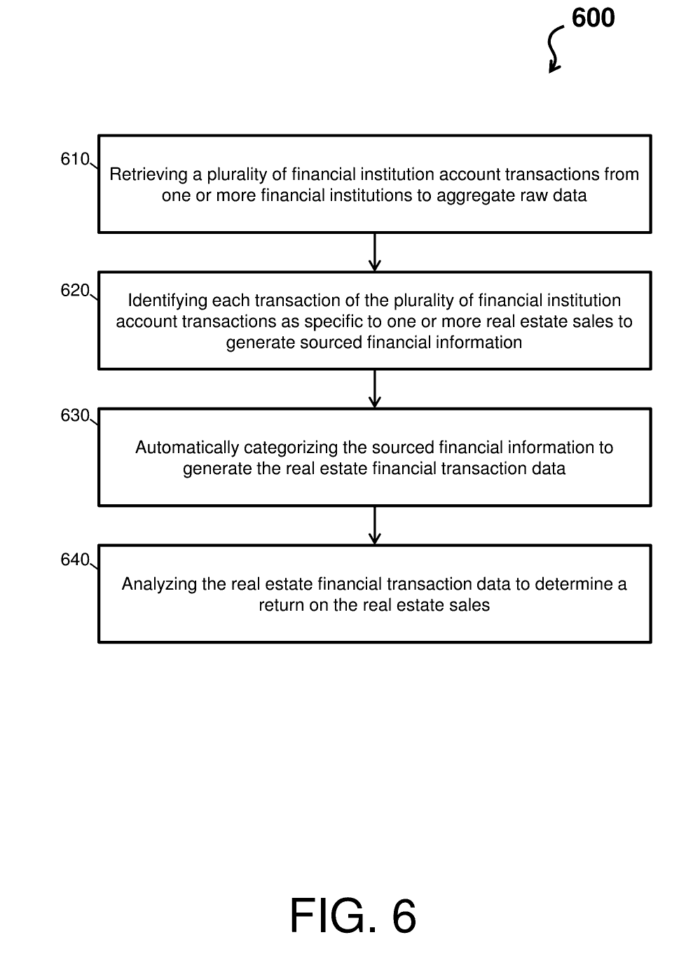

Turning now to FIG. 6, a process flow 600 for aggregating financial institution account transactions to create real estate financial transaction data is illustrated in accordance with one or more embodiments. In general, the process flow 600 executed by real estate management application can perform a sourcing of a credit transaction by identifying credit and debit transactions from a set of financial transactions; automatically categorizing the each of the credit and debit transactions according to descriptions associated with the credit and debit transactions; and receiving an input identifying a first debit transaction of the credit and debit transactions as a source of the first credit transaction. The process flow 600 can be implemented by the real estate financial management mechanism described herein (e.g., executed as software by the real estate finance management application).

The process flow 600 begins at block 610, where the real estate finance management application retrieves the plurality of financial institution account transactions from one or more financial institutions. In an example operation, the real estate finance management application can detect one or more user accounts registered with the real estate financial management application and send transactions requests to servers of the one or more financial institutions associated with the one or more user accounts. In turn, the real estate finance management application can receive the plurality of financial institution account transactions in response to the transactions requests.

Optionally, the real estate finance management application can associate corresponding transaction of the plurality of financial institution account transactions into the one or more user accounts, so that individual users can utilize the real estate finance management application to generate ROI %. Note that financial institutions provide services as intermediaries of financial markets. Examples of financial institutions depository institutions (e.g., banks, building societies, credit unions, trust companies, and mortgage loan companies), contractual institutions (e.g., insurance companies and pension funds), and investment institutions (e.g., investment banks, underwriters, and brokerage firms). Also, users of the real estate finance management application can add, update, and/or insert descriptions of the plurality of financial institution account transactions into their user account. Users of the real estate finance management application can add or insert manual transactions, along with descriptions of those manual transactions, which can be later used for sourcing and categorizing.

Next, the process flow 600 proceeds to automatically source the plurality of financial institution account transactions as described with respect to blocks 620 and 630.

At block 620, the real estate finance management application identifies each transaction of the plurality of financial institution account transactions as specific to one or more real estate sales to generate sourced financial information. Note the real estate finance management application can utilize descriptions and timestamps associated the individual account transactions. For instance, if a real estate agent has a preference for taking buyers to coffee before a real estate showing, all individual account transactions that include coffee or the like in the description and that include a timestamp that is within a few months (e.g., 6 months) of a date of a real estate sale can be sourced to that real estate sale. This is repeated for all individual account transactions of the raw data. Further, addresses of where the individual account transactions took place and the real estate sale can be used to distinguish between sourcing operations with respect to different sales.

At block 630, the real estate finance management application automatically categorizes the sourced financial information to generate the real estate financial transaction data. In one or more embodiments, categorizing can be the placement of the sourced financial information into the pre-bucketed budget line items. In this way, the pre-bucketed budget line items can be transaction categories and the sourced financial information can be stored in accordance with transaction categories. Note that description text of the transaction categories can be mapped to a unique institution transaction identifier for an internal industry specific category (a key table can also be utilized for this mapping). Further, the transaction categories can be defined geographically, such that the sourced financial information can be selected based on a geographic granularity (e.g., wherein the sourced financial information is categorized within the real estate financial transaction data according to transaction categories based on a geographic granularity). Geographic granularity refers to a size in which the sourced financial information can be divided and sub-divided. For example, geographic granularity can include a building, a street, a neighborhood, a district, a town, a city a postal code, a region, a state, a climate zone, a country, etc. geographic granularity cam be utilized by real estate agents and the brokerages to determine which sourced financial information is more effective on for different areas. Other examples of transaction categories can include, production level, years in business, etc.

At block 640, the real estate finance management application analyzes the real estate financial transaction data to determine a return on the real estate sales. In one embodiment, the return on the real estate sales can include a rendering of ROI %, such as those shown in the report section described in FIG. 5. The return on the real estate sales

The technical effects and benefits of sourcing of a credit transaction include an automated manipulation of the real estate financial transaction data for real estate agents into pre-bucketed budget line items to produce financial data that can be leveraged by return on investment reports and profit and loss statements. The technical effects and benefits of the real estate management application can include a single mechanism for aggregating bank accounts and credit cards to retrieve, source, categorize, and store the financial institution account transactions as the real estate financial transaction data, which real estate professionals can then access and manage. In this way, embodiments herein provide real estate professionals with industry-specific software that is necessarily rooted in a computer to automatically categorize and source the real estate financial transaction data.

For example, a database and analytics component of embodiments herein collects and deciphers information to support running a single agent's real estate business according to prescribed budget models. Once this information is aggregated into a data set stemming from thousands of agents, the data set will serve to support additional analytics that will be invaluable to brokers and large real estate companies. Also, as a tool for small brokerages to National franchisees, the data set and analytics thereof will assist with understanding by owners and managers of where agents are succeeding or failing in financial management. In turn, the data set and analytics thereof will enable queries on a multitude of scenarios, such as geographic, production level, years in business, etc.

According to one or more embodiments described herein, a method for sourcing a first credit transaction is provided. The method comprises identifying credit and debit transactions from a set of financial transactions; automatically categorizing the each of the credit and debit transactions according to descriptions associated with the credit and debit transactions; receiving an input identifying a first debit transaction of the credit and debit transactions as a source of the first credit transaction.

According to another embodiment or the method embodiment above, the method can comprise receiving a request for financial institution account transactions stored on servers of financial institutions associated with a user account; retrieving the financial institution account transactions in response to the request; and inserting the set of financial transaction financial transactions identified from the financial institution account transactions into the user accounts.

According to another embodiment or any of the method embodiments above, the method can comprise removing any identified pending transaction from the set of financial transaction financial transactions.

According to one or more embodiments described herein, a computer program product for sourcing a first credit transaction is provided. The computer program product comprises a computer readable storage medium having program instructions embodied therewith. The program instructions executable by a processor to cause the processor to identify credit and debit transactions from a set of financial transactions; automatically categorize the each of the credit and debit transactions according to descriptions associated with the credit and debit transactions; receive an input identifying a first debit transaction of the credit and debit transactions as a source of the first credit transaction.

According to another embodiment or the computer program product embodiment above, the program instructions can be executable by the processor to cause the processor to receive a request for financial institution account transactions stored on servers of financial institutions associated with a user account; retrieve the financial institution account transactions in response to the request; and insert the set of financial transaction financial transactions identified from the financial institution account transactions into the user accounts.

According to another embodiment or any of the computer program product embodiments above, the program instructions can be executable by the processor to cause the processor to remove any identified pending transaction from the set of financial transaction financial transactions.

According to one or more embodiments described herein, a system for sourcing a first credit transaction is provided. The system comprises a memory having computer readable instructions and a processor for executing the computer readable instructions. The computer readable instructions, when executed by the processor, cause the system to identify credit and debit transactions from a set of financial transactions; automatically categorize the each of the credit and debit transactions according to descriptions associated with the credit and debit transactions; receive an input identifying a first debit transaction of the credit and debit transactions as a source of the first credit transaction.

According to another embodiment or the system embodiment above, the computer readable instructions can be executable by the processor to cause the system to receive a request for financial institution account transactions stored on servers of financial institutions associated with a user account; retrieve the financial institution account transactions in response to the request; and insert the set of financial transaction financial transactions identified from the financial institution account transactions into the user accounts.

According to another embodiment or any of the system embodiments above, the computer readable instructions can be executable by the processor to cause the system to remove any identified pending transaction from the set of financial transaction financial transactions.

Embodiments herein can be a system, a method, and/or a computer program product. The computer program product may include a computer readable storage medium (or media) having computer readable program instructions thereon for causing a processor to carry out aspects of the embodiments herein. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments herein.

Aspects of embodiments are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof

The corresponding structures, materials, acts, and equivalents of all means or step plus function elements in the claims below are intended to include any structure, material, or act for performing the function in combination with other claimed elements as specifically claimed. The description of the embodiments herein has been presented for purposes of illustration and description, but is not intended to be exhaustive or limited in the form disclosed. Many modifications and variations will be apparent to those of ordinary skill in the art without departing from the scope and spirit of the embodiments herein. The embodiment was chosen and described in order to best explain the principles of the embodiments herein and the practical application, and to enable others of ordinary skill in the art to understand the various embodiments herein with various modifications as are suited to the particular use contemplated.

What is claimed is:

1. A computer-implemented method for aggregating a plurality of financial institution account transactions to generate real estate financial transaction data, the computer-implemented method comprising:
retrieving, by a processor coupled to a memory, the plurality of financial institution account transactions from one or more financial institutions;
automatically sourcing, by the processor, the plurality of financial institution account transactions by:
identifying each transaction of the plurality of financial institution account transactions as specific to one or more real estate sales to generate sourced financial information, and
automatically categorizing the sourced financial information to generate the real estate financial transaction data; and
analyzing, by the processor, the real estate financial transaction data to determine a return on the real estate sales.

2. The computer-implemented method of claim 1, wherein retrieving of the plurality of financial institution account transactions from the one or more financial institutions comprises:
detecting one or more user accounts registered with a real estate financial management application executed by the processor;
sending transactions requests to servers of the one or more financial institutions associated with the one or more user accounts;
receiving the plurality of financial institution account transactions in response to the transactions requests; and
associating corresponding transaction of the plurality of financial institution account transactions into the one or more user accounts.

3. The computer-implemented method of claim 1, wherein the one or more financial institutions comprises depository institutions, contractual institutions, and investment institutions.

4. The computer-implemented method of claim 1, wherein the plurality of financial institution account transactions include pending transaction, credit transactions, and debit transactions.

5. The computer-implemented method of claim 1, wherein identifying of the individual account transactions as specific to the one or more real estate sales to generate sourced financial information comprises utilizing descriptions and timestamps associated the individual account transactions

6. The computer-implemented method of claim 1, wherein the sourced financial information is categorized within the real estate financial transaction data according to transaction categories based on a geographic granularity.

7. The computer-implemented method of claim 1, wherein analyzing the real estate financial transaction data to determine the return on the real estate sales comprises:
rendering a total return on investment report and an income report.

8. The computer-implemented method of claim 7, wherein the total return on investment report comprises relationships between profits and expenses found in the real estate financial transaction data to enable the income report to provide a value for a return on investment percentage.

9. A computer program product for aggregating a plurality of financial institution account transactions to generate real estate financial transaction data, the computer program product comprising a computer readable storage medium having program instructions embodied therewith, the program instructions executable by a processor to cause the processor to:
retrieve the plurality of financial institution account transactions from one or more financial institutions;
automatically source the plurality of financial institution account transactions by:
identifying each transaction of the plurality of financial institution account transactions as specific to one or more real estate sales to generate sourced financial information, and
automatically categorizing the sourced financial information to generate the real estate financial transaction data; and
analyze the real estate financial transaction data to determine a return on the real estate sales.

10. The computer program product of claim 9, wherein retrieving of the plurality of financial institution account transactions from the one or more financial institutions comprises:
detecting one or more user accounts registered with a real estate financial management application executed by the processor;
sending transactions requests to servers of the one or more financial institutions associated with the one or more user accounts;
receiving the plurality of financial institution account transactions in response to the transactions requests; and
associating corresponding transaction of the plurality of financial institution account transactions into the one or more user accounts.

11. The computer program product of claim 9, wherein the one or more financial institutions comprises depository institutions, contractual institutions, and investment institutions.

12. The computer program product of claim 9, wherein the plurality of financial institution account transactions include pending transaction, credit transactions, and debit transactions.

13. The computer program product of claim 9, wherein identifying of the individual account transactions as specific to the one or more real estate sales to generate sourced financial information comprises utilizing descriptions and timestamps associated the individual account transactions

14. The computer program product of claim 9, wherein the sourced financial information is categorized within the real estate financial transaction data according to transaction categories based on a geographic granularity.

15. The computer program product of claim 9, wherein analyzing the real estate financial transaction data to determine the return on the real estate sales comprises:
rendering a total return on investment report and an income report.

16. The computer program product of claim 15, wherein the total return on investment report comprises relationships between profits and expenses found in the real estate financial transaction data to enable the income report to provide a value for a return on investment percentage.

17. A system for aggregating a plurality of financial institution account transactions to generate real estate financial transaction data, the system comprising a processor and a memory storing program instructions thereon, the program instructions executable by the processor to cause the system to:
retrieve the plurality of financial institution account transactions from one or more financial institutions;
automatically source the plurality of financial institution account transactions by:
identifying each transaction of the plurality of financial institution account transactions as specific to one or more real estate sales to generate sourced financial information, and
automatically categorizing the sourced financial information to generate the real estate financial transaction data; and
analyze the real estate financial transaction data to determine a return on the real estate sales.

18. The system of claim 17, wherein retrieving of the plurality of financial institution account transactions from the one or more financial institutions comprises:
detecting one or more user accounts registered with a real estate financial management application executed by the processor;
sending transactions requests to servers of the one or more financial institutions associated with the one or more user accounts;
receiving the plurality of financial institution account transactions in response to the transactions requests; and
associating corresponding transaction of the plurality of financial institution account transactions into the one or more user accounts.

19. The system of claim 17, wherein the one or more financial institutions comprises depository institutions, contractual institutions, and investment institutions.

20. The system of claim 17, wherein the plurality of financial institution account transactions include pending transaction, credit transactions, and debit transactions.
